(19) United States
(12) Patent Application Publication
(10) Pub. No.: US 2009/0292951 A1
(43) Pub. Date: Nov. 26, 2009

(54) METHOD AND DEVICE FOR FAULT LOCATION IN A SYSTEM

(75) Inventors: Francois Fournier, Roques/Sur/Garonne (FR); Christian Sannino, Muret (FR); Carine Bailly, Tournefeuille (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/465,248

(22) Filed: May 13, 2009

(30) Foreign Application Priority Data
May 13, 2008 (FR) 08 02589

(51) Int. Cl. G06F 11/28

(52) U.S. Cl. 714/37; 714/E11.178

(57) ABSTRACT

The invention relates to a method and a device for locating a fault in a system. The system includes a set of elements. The elements are connected in a network. Each element is associated with an operational status and a probability of failure. The method according to an embodiment of the invention includes, for each of the elements having a status indicating a malfunction, denoted as a defective element, the creation, from the system topology, of an expression comprising terms corresponding to functional elements connected to said defective element. If several expressions have been created in the preceding step, then merge expressions having at least one term in common. For each expression, delete terms in the expression corresponding to elements having a “healthy” status. Calculate a minimal expression from the preceding expression. Calculate failure probabilities for selected members of the minimal expression based on failure probabilities of the corresponding elements. Calculate the location of the fault to the elements corresponding to the members of the minimal expression for which the ratio of failure probabilities to exposure time is greater than a threshold.

### CROSS-REFERENCE TO RELATED APPLICATION

The present application claims the benefit of French Patent Application No. 08 02589, filed May 13, 2008, which is hereby incorporated by reference in its entirety.

### TECHNICAL FIELD

The invention relates to the maintenance of a set of equipment, such as the set of aviation equipment situated in the cabin or on the passenger side of a civil or military aircraft which fulfils, for example, the diverse functions necessary for completing a flight. The invention relates more specifically to the location of a fault in such a set of equipment.

### BACKGROUND OF THE INVENTION

These pieces of equipment communicate with each other and with the surroundings through a physical network. This communication network, associated with a set of equipment, is known by the name ADCN, for Avionics Data Communication Network.

The fault location is based on a reliable diagnosis of all or part of this set of equipment. Such a diagnosis must take into account the topology of this set and its evolutions. The diagnosis must also take account of the interactions between different systems and in particular the nature of the physical components of the ADCN (discrete, ARINC 429, multiplexed, wireless, etc.). In the context of an avionics suite, this maintenance system may be either the CFDIU (Central Fault Display Interface Unit) or CMF (Central Maintenance Function) centralized maintenance system, or a BITE (Built In Test) at system, resource or even application level, or a system independent of the system to be maintained, for example a maintenance system on the ground for maintaining an aircraft.

According to the prior art, the problem of fault location is solved by a maintenance system using a probability of equipment failure (based or not based on the MTBF—Mean Time Between Failure) using a mean exposure time common to all the elements of the system, but not using the time of specific and real (i.e. non-mean) exposure of the group of equipment, of the piece of equipment or of part of the equipment monitored. The exposure time corresponds to the time between the last moment that an anomaly detection mechanism has detected nothing and the moment that it detects an anomaly and sends an error message. The exposure time is therefore the time between the last test performed not indicating any problem and the test where the problem is first observed. The exposure time may be of the order of one minute. The mean exposure time is of the order of one or several flights, i.e. of the order of several hours.

In addition, the methods of fault location process messages coming from equipment that are often erroneous, as these messages contain the names of pieces of equipment defined during development but do not take account of the evolutions and the topology of the system, or as they voluntarily omit part of the potentially faulty equipment due to a lack of space in the message.

Generally speaking, the fault location systems according to the prior art carry out a certain number of approximations concerning the representation of the set of equipment to be diagnosed. For example, in the case in which a piece of equipment A is communicating with a piece of equipment B and with a piece of equipment C: if B points to A and C points to A, then A is faulty without taking account of the physical links and the topology of the network between A, B and C. These approximations may lead to erroneous location of a fault. For example, the fault location systems according to the known prior art do not distinguish the testable or untestable parts of the system elements. The probability of a component fault is much greater than the probability of a fault in the untestable part of a connector of the same component (ratio 100 to 1000). In the prior art, the connector is not distinguished from the component; an erroneous probability is therefore used when this connector is faulty.

### SUMMARY OF THE INVENTION

Embodiments of the invention aims to alleviate these problems notably by proposing a method and a device for fault location in a system. To this end, the subject of the invention is a method for locating a fault in a system, said system including a set of equipment connected in a network according to a given network topology, said method being implemented on a maintenance computer including a model of said system and of the topology, characterized in that it includes:

breaking down the system into functional elements, an element being a piece of equipment or a receiver connector or a transmitter connector or a link;

identifying each element by a term;

associating an operational status and a probability of failure with each element;
and in that it includes the following steps:

for each of the elements whose status indicates a disfunction (i.e., a maufunction), such an element being denoted a defective element, the creation, from the model, of an expression including the term for this element and the terms corresponding to the system elements connected to said defective element in said topology;

if several expressions have been created in the preceding step, a merging of the expressions having at least one term in common;

for each expression:
the deletion of terms in the expression corresponding to elements having a “healthy” status;

the calculation of a minimal expression from the preceding expression, a minimal expression including simple terms and products of terms;

the calculation of failure probabilities for various simple terms and products of terms from the minimal expression based on failure probabilities of the corresponding elements;

the calculation of a ratio Rᵢ for each term of the minimal expression, the ratio Rᵢ satisfying the following equation: Rᵢ=Pₘₐₓ/Pᵢ with Pᵢ being the probability of failure of the term for which the ratio is being calculated and Pₘₐₓ being the highest probability of failure among the terms of the minimal expression, and the display of terms from the expression for which the ratio Rᵢ is greater than a threshold S1.

According to one feature of the invention, the step of creating the expression applied to a receiver connector CrA produces an expression, the terms of which correspond to said receiver connector CrA, to all the transmitter connectors CéBi to which said receiver connector is connected, to the pieces of equipment Bi including said transmitter connectors and to the links Li connecting said transmitter connectors and said receiver connector, said expression being of the form (CrA+CéB1+ . . . +CéBn+B1+ . . . +Bn+L1+ . . . +Ln), n being the number of links and the number of transmitter connectors to which the receiver connector CrA is connected.

Generally speaking, for the analogue, the discrete numbers, of the 429 and of the AFDX there is always a single transmitter and several receivers (n=1). But there are also problems of wireless links and it is possible for there to be several transmitters and several receivers (n>).

According to one feature of the invention, the merging step relates to k expressions E₁, . . . , Eₖ, k being an integer greater than 1, and includes the creation of an expression of the type (E₁).(E₂).( . . . ).(Eₖ).

According to one feature of the invention, the step of calculating a minimal expression includes the application of the two following rules:

a first rule, A.A=A, for simplifying a product of terms including several identical terms; and

a second rule, A+A=A, for simplifying an expression including several identical terms;
so as to obtain a minimal expression of the type Σ(ΠA B), A and B being terms of an expression.

According to one feature of the invention, the step of calculating probabilities of failure of the various simple terms and products of terms from the minimal expression using failure probabilities P(Ai) of the corresponding elements Ai includes the application of the following rule: P(ΠAᵢ)=Π P (Aᵢ).

This feature has the advantage of converting the topology of the system described in the model, then expressed in the form of an expression, into terms of failure probabilities.

According to one feature of the invention, the elements being transmitter connectors CéBi, a receiver connector CrA, pieces of equipment Bi and links Li, the method according to the invention furthermore includes a step of attributing a “healthy” status:

to all the transmitter connectors CéBi connected to a receiver connector CrA having a “healthy” status;

to the pieces of equipment Bi including said transmitter connectors CéBi; and

to the links Li connecting said transmitter connectors CéBi and said receiver connector CrA.

According to one feature of the invention, the method according to an embodiment of the invention furthermore includes a step of displaying the elements where the fault is located, said elements being presented in order of decreasing failure probability.

According to one feature of the invention, the status associated with the elements is attributed on the basis of information from error messages.

According to one feature of the invention, the failure probability associated with each element depends on its duration of exposure.

According to one feature of the invention, the method according to the invention also makes it possible to locate anomalies that are not faults for elements having a status “other”, “switched off” or “downloading”, or for inaccessible elements.

According to one feature of the invention, the threshold S1 may be changed. This feature has the advantage of enabling the maintenance operator, for example, to increase or lower the threshold S1 and thus to vary the number of elements designated as faulty. Thus the maintenance operator is not saturated by the information delivered by the method according to the invention.

The subject of the invention is also a device for fault location in a system, said system including a set of elements, said elements being connected in a network, characterized in that it includes means of implementing the method according to an embodiment of the invention.

The method according to an embodiment of the invention has the advantage of taking into account:

the operational status of system elements, their failure probability (pieces of equipment, connectors and physical links, etc.) and their real exposure time;

a threshold from which the failure probability for a group of equipment is neglected without deleting this equipment, such a threshold making it possible to provide a sufficiently precise indication to a maintenance operator without overloading him with too large an amount of indications;

the system topology, described in a model, to establish the real links between pieces of equipment (which piece of equipment is connected to which other by which connectors and which links) in order to constitute the exhaustive list of equipment connected, without forgetting any, then in order to eliminate healthy equipment from a list of potentially faulty equipment, which has the advantage of thus producing more reliable and more precise fault location while simplifying the expression obtained after the step of merging expressions;

messages pointing to transmitter or receiver connectors belonging to the equipment;

multiple faults, simultaneous or otherwise, because at no time does the method according to the invention assume a simple fault.
Aspects of the invention also make it possible:

to distinguish the testable and untestable parts of the system elements by using the correct failure probabilities, therefore the order of the list of potentially faulty elements is the correct one.

According to the prior art, a BITE (for Built In Test Equipment) function transmitting an operational report sends a message pointing to at most three pieces of LRU (for Line Replaceable Unit) equipment on A320 and A340 and at most four LRUs on A380. According to an embodiment of the invention, the message does not contain a limited list of LRUs, but contains a link or a path arriving at a connector. Using this information and knowledge of the system topology, the method according to an embodiment of the invention establishes the set of potentially faulty equipment without limitation.

### BRIEF DESCRIPTION OF THE DRAWINGS

Aspects of the invention will be better understood and further advantages will become apparent on reading the detailed description, provided by way of nonlimiting example and using the figures, among which:

FIG. 1 shows a flow chart describing an exemplary application of the method according to the invention.

FIG. 2 shows a first example of a set of equipment connected to each other.

FIG. 3 shows a second example of a set of equipment connected to each other.

### DETAILED DESCRIPTION OF THE INVENTION

Aspects of the invention relates to a method and a device for fault location in a system. The system includes a set of elements. The elements are connected in a network. Each element is associated with a failure probability and with a real exposure time.

Each real piece of equipment communicating on the physical network contains at least one physical component directly connected to the network that will be called the connector: either transmitter connector (the piece of equipment transmits data on the network) and/or receiver connector (the piece of equipment acquires data circulating on the network). Some pieces of equipment serve to transmit the data on the network. They are called “switches” and have transmitter and receiver connectors. The relation between a transmitter connector of one piece of equipment and a receiver connector of another piece of equipment is called a “link”. A link may be broken down into “sublinks” and into connectors connected directly to each other. A sublink may be common to several links. These links may be connected to each other by link connectors.

According to one feature of the invention, an element is a piece of equipment or a receiver connector or a transmitter connector or a link. Every element is identified (of the type name, serial number, version number, provider name, etc.) and located (of the type index number, physical location) uniquely in this set.

From data from analyses of the operational security of the set of real equipment each piece of equipment is associated with a failure probability denoted ‘P’. The failure probability (probability of becoming faulty) during the exposure time T is equal, in certain conditions, to a failure rate ‘λ’ multiplied by T. The failure rate defines a probability of a fault occurring:

for each receiver connector: the failure probability for the untestable part of the connector during the real exposure time of the receiver connector;

for each transmitter connector: the failure probability of the untestable part of the connector during the real exposure time of the transmitter connector;

for each piece of equipment: the failure probability of the equipment without the untestable parts of the connectors during the real exposure time of the equipment;

for each switch: the failure probability of the switch without the untestable parts of the connectors during the real exposure time of the switch;

for each link: the failure probability of the link during the real exposure time of the link.

According to one feature of the invention, the fault location method includes a step including attributing a fault status to equipment from information from error messages. The pieces of equipment transmit error messages which either point to them directly or point to their own physical transmitter or receiver connector independently of the identity of transmitters or receivers. This step has the advantage of enabling the attribution of a fault status to all the elements, including those not having means for transmitting error messages (for example, the physical links and the connectors). The various possible statuses for a piece of equipment are:

“healthy”, when the piece of equipment (or switch) declares itself to be without internal fault (“I am not faulty”), even if it transmits error messages pointing to one of these connectors (“Loss of communication” or “Communication error”);

“faulty”, when the piece of equipment (or switch) transmits an internal error message (“I am faulty”) while distinguishing, if necessary, the states: “Total loss”, “Erroneous behaviour” or “Untimely behaviour”;

“other”, when the piece of equipment (or switch) declares itself to be in a nonoperational mode (in download mode, for example) which does not correspond to a fault mode, when it is being reset (voluntary relaunching of the function) or when it has undergone a cut in power supply; and

“unknown”, when no information is received to allow one of the two first statuses to be determined.

For the connectors associated with a piece of equipment (or switch) or the links, a status is associated:

“loss of communication at connector X”, when the piece of equipment (or switch) is no longer receiving physically valid data from its receiver connector X (for example, cut-off of the communication, parity problem, CRC problem) while distinguishing, if necessary, the states: “Total loss”, “Erroneous behaviour” or “Untimely behaviour”;

“unknown”, when no information is being received to allow determination of the first status. This is in general the case when the status of the equipment is “unknown”.

The paragraphs below describe various exemplary implementations of the method according to the invention.

The method according to the invention is implemented on a maintenance computer comprising a model of the system to be diagnosed. Such a model is described in the French patent application FR 0704012. This model describes the network topology and comprises a representation of the equipment in the network, notably with their operational status and data coming from the analysis of operational security.

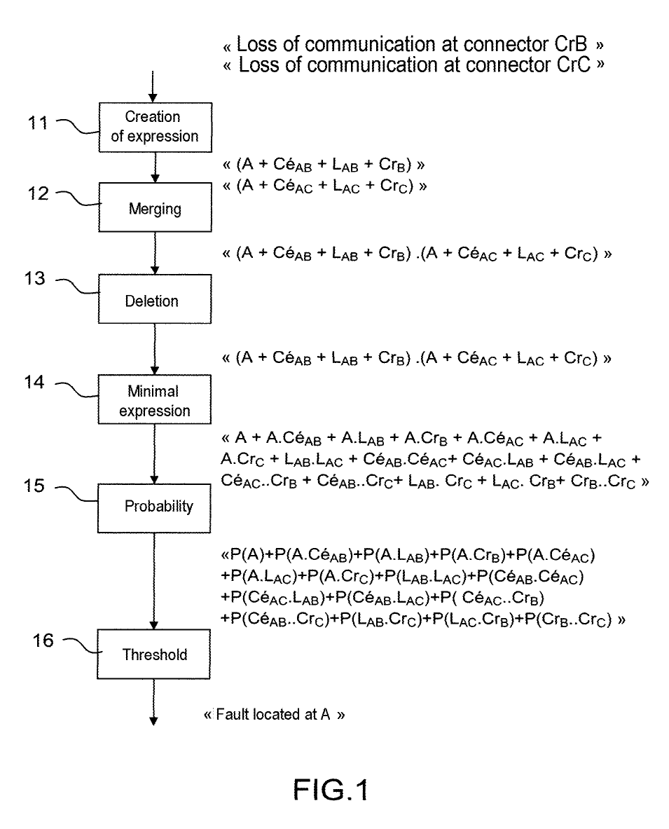

FIG. 1 shows a flow chart describing an exemplary application of the method according to the invention corresponding to a first fault case.

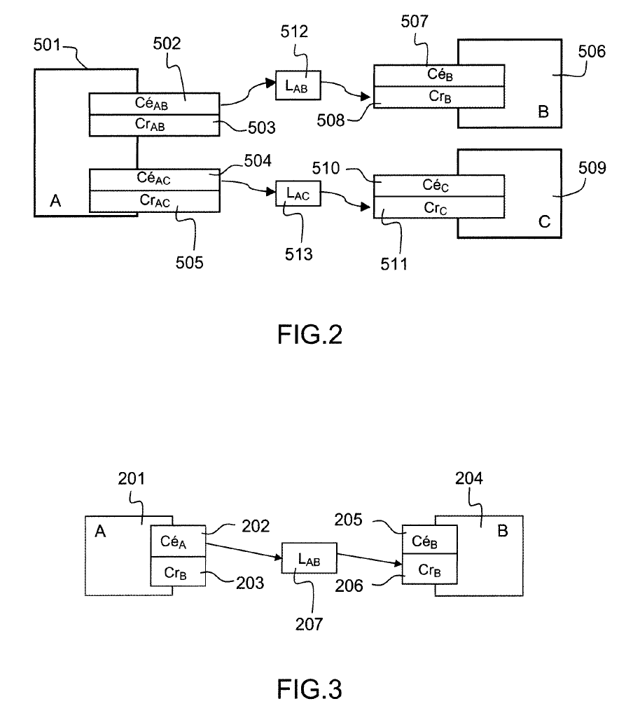

In the first fault case, a system comprising three pieces of equipment is considered. FIG. 2 shows such a system. This system comprises a first piece of equipment A 501 comprising a first transmitter connector Cé_{AB} 502, a first receiver connector Cr_{AB} 503, a second transmitter connector Cé_{AC} 504 and a second receiver connector Cr_{AC} 505. This system also comprises a second piece of equipment B 506 comprising a third transmitter connector Cé_{B} 507 and a third receiver connector Cr_{B} 508. This system furthermore comprises a third piece of equipment C 509 comprising a fourth transmitter connector Cé_{C} 510 and a fourth receiver connector Cr_{c} 511.

A first link L_{AB} 512 connects the first transmitter connector Cé_{AB} 502 and the third receiver connector Cr_{B} 508. A second link 513 L_{AC} connects the second transmitter connector Cé_{AC} 504 and the fourth receiver connector Cr_{C} 511.

Generally speaking, it can be assumed that the failure probability of a piece of equipment is greater than that of a connector (which almost always proves to be true), which is itself greater than that of a link. It is also possible to assume that the failure probability for a transmitter connector is greater than that for a receiver connector.

The status of the connector Cr_{B} 508 is “Loss of communication at connector Cr_{B}”. The status of the connector Cr_{C} 511 is “Loss of communication at connector Cr_{C}”. The status of the piece of equipment A 501 is “Unknown”. The system topology as described in the model of the maintenance computer makes it possible to directly identify the path of data arriving at the connector Cr_{B}, and therefore in the case of this example: the link L_{AB} 512, the connector Cé_{AB} 502 and the piece of equipment A 501. Likewise, the system directly identifies the path of data arriving at the connector Cr_{C} 511, and therefore in the case of this example: the link L_{AC} 513, the connector Cé_{AC} 504 and the piece of equipment A 501. From Cr_{B}, the step of creating an expression produces an expression: “A+Cé_{AB}+L_{AB}+Cr_{B}”. From CrC, the step of creating an expression produces an expression “A+Cé_{AC}+L_{AC}+Cr_{C}”.

The merging step applied to the two preceding expressions having the term A in common produces the expression: “(A+CéAB+LAB+CrB).(A+CéAC+LAC+CrC)”.

In the following step, no term is deleted as no element is in a healthy state.

The step of calculating a minimal expression makes it possible to reduce the equation in the following manner: “A+A.CéAB+A.LAB+A.CrB+A.CéAC+A.LAC+A.CrC+LAB.LAC+CéAB.CéAC+CéAC.LAB+CéAB.LAC+CéAC.CrB+CéAB.CrC+LAB.CrC+LAC.CrB+CrB.CrC”.

The following step makes it possible to calculate the failure probabilities of the terms of the expression: “P(A)+P(A.CéAB)+P(A.LAB)+P(A.CrB)+P(A.CéAC)+P(A.LAC)+P(A.CrC)+P(LAB.LAC)+P(CéAB.CéAC)+P(CéAC.LAB)+P(CéAB.LAC)+P(CéAC.CrB)+P(CéAB.CrC)+P(LAB.CrC)+P(LAC.CrB)+P(CrB.CrC)”.

According to a variant of the invention it is possible to classify the terms in decreasing order of failure probability: P(A)>P(A.CéAB)>P(A.CrB)>. . . .

On the assumption that P(A)/P(A.CéAB)>S1, the location method makes it possible to conclude: “A is faulty”.

FIG. 3 shows a second example of a set of equipment connected to each other. This set of equipment comprises a first piece of equipment A 201 comprising a first transmitter connector Cé_{A} 202 and a first receiver connector Cr_{A} 203. The set of equipment also comprises a second piece of equipment B 204 comprising a second transmitter connector Cé_{B} 205 and a second receiver connector Cr_{B} 206. A link L_{AB} 207 connects the first transmitter connector Cé_{A} 202 and the second receiver connector Cr_{B} 206.

In a second fault case it is assumed that the status of the first piece of equipment 201 is “faulty”, indicated by an error message.

The step of creating an expression produces an expression “A”. The merging step does not apply because a single expression has been produced. In the following step, no term is deleted as no element has a healthy status. The corresponding minimal expression comprises a single term: A. The method according to an embodiment of the invention makes it possible to conclude that the piece of equipment A 201 is faulty.

In a third fault case the second example of a set of equipment is considered. It is assumed that the status of the second receiver connector Cr_{B} 206 is “Loss of communication at connector Cr_{B}”. The status of the first piece of equipment A 201 is “healthy”.

The step of creating an expression takes account of the system topology and, in particular, the path of data arriving at the second receiver connector Cr_{B} 206: the link L_{AB} 207, the first transmitter connector Cé_{A} and the first piece of equipment A. The step leads to the creation of the expression “A+Cé_{A}+LAB+Cr_{B}”. The merging step does not apply because a single expression has been produced. In the following step, the A is deleted from the expression: “Cé_{A}+LAB+Cr_{B}”. The corresponding minimal expression is identical. These elements are classified in decreasing order of failure probability: P(LAB)>P(CéA)>P(CrB). The method according to the invention makes it possible to conclude: “LAB or CéA or CrB faulty” ordered in decreasing order of failure probability.

According to one feature of the invention, the failure probability associated with each element depends on its exposure duration. This probability has the advantage of being more precise than the notion of MTBF generally used in the systems according to the prior art. From real data provided by the system, an exposure time T that corresponds to the time between the last moment that an anomaly detection mechanism has detected nothing and the moment that it has detected the anomaly and sends an error message is associated with each error message and therefore with each element potentially pointed to by this message. Each element of the aircraft possesses an internal mechanism, hardware and/or software, for detecting anomalies known by the name of “monitoring”. Monitoring has the task of transmitting alarms to the pilot to warn him of a possible sudden unavailability of a monitored piece of equipment. Each element considered is then associated with its probability of failure during T: P( )=λ( ).T if P( )<10⁻² or P( )=1−e^{-λ( ).T} otherwise (i.e. according to a Poisson distribution). The exposure time is different for each element. Depending on the nature of the message and the nature of the detection mechanism, T may differ. It is then assumed that the probability P( ) is calculated by integrating the various values of the exposure time T, in contrast to the prior art, where the failure rate is reduced to a common mean exposure time.

The subject of the invention is also a device for fault location in a system, said system comprising a set of elements, said elements being connected in a network according to a determined topology, characterized in that it comprises means for implementing the method according to the preceding description.

The device for fault location is integrated into a maintenance computer comprising a model of the system and of the topology. The device according to an embodiment of the invention comprises:

means for breaking down the system into functional elements, an element being a piece of equipment or a receiver connector or a transmitter connector or a link;

means for identifying each element by a term;

means for associating an operational status and a failure probability with each element;
and in that it comprises:

means for the creation, based on the model, for each of the elements whose status indicates a disfunction (i.e., a malfunction), such elements being denoted defective elements, an expression comprising the term of this element and the terms corresponding to the elements of the system linked to said defective element in said topology;

means for merging expressions having at least one term in common;

means for the deletion of terms in the expression corresponding to elements having a “healthy” status;

means for calculating a minimal expression, a minimal expression comprising simple terms and products of terms;

means for calculating failure probabilities of various simple terms and products of terms from the minimal expression from failure probabilities of the corresponding elements;

means for the calculation of a ratio Ri for each term of the minimal expression, the ratio Ri satisfying the following equation: Rᵢ=Pₘₐₓ/Pᵢ with Pᵢ being the probability of failure of the term for which the ratio is being calculated and Pₘₐₓ being the highest probability of failure among the terms of the minimal expression, and the display of terms from the expression for which the ratio Rᵢ is greater than a threshold S1.

The method and the device according to an embodiment of the invention also make it possible to locate anomalies that are not faults, for example elements having a status “other” such as “switched off” or “downloading”.

The method and the device according to an embodiment of the invention also make it possible to determine the inaccessible pieces of equipment: all the elements (pieces of equipment, links, connectors) which are connected to it and are either “faulty” or in a state “other”.

1. A method for locating a fault in a system, said system comprising a set of equipment connected in a network according to a predetermined network topology, said method being implemented on a maintenance computer having a model of said system and the predetermined network topology, wherein the method comprises the steps of:
breaking down the system into functional elements, wherein a functional element comprises one of a piece of equipment, a receiver connector, a transmitter connector, and a link;
identifying each functional element by a mathematical term;
associating an operational status and a probability of failure with each functional element to identify one or more defective elements, wherein each defective element comprises a functional element whose operational status indicates a malfunction;
for each defective element, creating an expression, from the model, comprising the mathematical term for the defective element and mathematical terms corresponding to functional elements connected to said defective element in said predetermined network topology, to form a first plurality of expressions;
merging selected expressions, within the first plurality of expressions, having at least one mathematical term in common, to produce a second plurality of expressions; and
for each expression within the second plurality of expressions, performing the steps of:
deleting mathematical terms that correspond to functional elements having a status of healthy, to produce a second expression;
calculating simple mathematical terms and products of mathematical terms from the second expression to produce a minimal expression;
calculating failure probabilities for selected simple mathematical terms and products of mathematical terms from the minimal expression based on failure probabilities of the corresponding functional elements;
calculating, for each mathematical term of the minimal expression, a ratio R₁ determined in accordance with the following relationship:
Rᵢ=Pₘₐₓ/Pᵢ
wherein:
Pᵢ comprises a probability of failure of the mathematical term for which the ratio Rᵢ is being calculated; and
Pₘₐₓ comprises a highest probability of failure among the mathematical terms of the minimal expression; and
the method further comprising the step of displaying mathematical terms from the minimal expression for which the ratio Rᵢ is greater than a predetermined threshold.

2. The method according to claim 1, wherein the step of creating the expression applied to a receiver connector CrA produces a CrA-expression, wherein mathematical terms of the CrA-expression correspond to:
said receiver connector CrA;
all the transmitter connectors CéBi to which said receiver connector is connected;
pieces of equipment Bi comprising said transmitter connectors; and
links Li connecting said transmitter connectors and said receiver connector,
wherein said CrA-expression is determined in accordance with the following relationship:
(CrA+CéB1+ . . . +CéBn+B1+ . . . +Bn+L1+ . . . +Ln),
wherein n comprises a number of links and a number of transmitter connectors to which the receiver connector CrA is connected.

3. The method according to claim 1, wherein the step of merging equations utilizes k expressions E₁, . . . , Eₖ, k being an integer greater than 1, and comprises the further step of creating an expression of type (E₁).(E₂).( . . . ).(Eₖ) comprising products of mathematical terms.

4. The method according to claim 1, wherein the step of calculating a minimal expression comprises the steps of:
applying a first rule, A.A=A, to simplify a product of mathematical terms comprising several identical terms; and
applying a second rule, A+A=A, to simplify an expression comprising several identical mathematical terms;
to produce a minimal expression of a type Σ(ΠA B), wherein A and B comprise mathematical terms of the minimal expression.

5. The method according to claim 1, wherein the step of calculating probabilities of failure of simple mathematical terms and products of mathematical terms from the minimal expression by use of failure probabilities P(Ai) of corresponding functional elements Ai comprises applying a rule determined in accordance with the following relationship:
P(ΠAᵢ)=Π P(Aᵢ).

6. The method according to claim 1, wherein the functional elements comprise one or more transmitter connectors CéBi, a receiver connector CrA, one or more pieces of equipment Bi and one or more links Li, further comprising the step of:
attributing a “healthy” status to:
all of the one or more transmitter connectors CéBi connected to a receiver connector CrA having a “healthy” status;
the one or more pieces of equipment Bi in communication with said transmitter connectors CéBi; and
the links Li connecting said transmitter connectors CéBi and said receiver connector CrA.

7. The method according to claim 1, further comprising a step of displaying mathematical terms from the minimal expression for which the ratio Rᵢ is greater than the predetermined threshold in order of decreasing failure probability.

8. The method according to claim 1, wherein a status associated with each functional element is based on information from error messages.

9. The method according to claim 1, wherein a failure probability associated with each functional element depends on a duration of exposure.

10. The method according to claim 1, wherein the method is used to locate anomalies for inaccessible functional elements and functional elements having a status selected from the group consisting of “other”, “switched off” and “downloading”.

11. The method according to claim 1, wherein the threshold is changeable.

12. A device for fault location in a system, said system comprising a set of elements, said elements being connected in a network according to a predetermined network topology, comprising a processor and a memory containing instructions for execution by the processor, the processor and the memory configured to perform the steps of:
breaking down the system into functional elements, wherein a functional element comprises one of a piece of equipment, a receiver connector, a transmitter connector, and a link;
identifying each functional element by a mathematical term;
associating an operational status and a probability of failure with each functional element to identify one or more defective elements, wherein each defective element comprises a functional element whose operational status indicates a malfunction;
for each defective element, creating an expression, from the model, comprising the mathematical term for the defective element and mathematical terms corresponding to functional elements connected to said defective element in said predetermined network topology, to form a first plurality of expressions;
merging expressions, within the first plurality of expressions, having at least one mathematical term in common, to produce a second plurality of expressions; and
for each expression within the second plurality of expressions, performing the steps of:
deleting mathematical terms that correspond to functional elements having a status of healthy, to produce a second expression;
calculating simple mathematical terms and products of mathematical terms from the second expression to produce a minimal expression;
calculating failure probabilities for selected simple mathematical terms and products of mathematical terms from the minimal expression based on failure probabilities of the corresponding functional elements;
calculating, for each mathematical term of the minimal expression, a ratio Rᵢ determined in accordance with the following relationship:
Rᵢ=Pₘₐₓ/Pᵢ
wherein:
Pᵢ comprises a probability of failure of the mathematical term for which the ratio Rᵢ is being calculated; and
Pₘₐₓ comprises a highest probability of failure among the mathematical terms of the minimal expression; and
the method further comprising the step of displaying mathematical terms from the minimal expression for which the ratio Rᵢ is greater than a predetermined threshold.

13. The device for fault location in a system according to claim 12, said system comprising a set of equipment connected in a network according to a predetermined network topology, said device being integrated into a maintenance computer having a model of said system and of the predetermined network topology.
